(19) United States
(12) Patent Application Publication
(10) Pub. No.: US 2010/0060887 A1
(43) Pub. Date: Mar. 11, 2010

(54) METHOD FOR DETECTING MEMBRANE MODULE FLAW WITH THE APPLICATION OF FLUORESCENT PARTICLES

(75) Inventors: Jin Woo Cho, Seoul (KR); Ki Pal Kim, Chungcheongnam-do (KR); Kyu-Hwan Shim, Seoul (KR); Kyung Guen Song, Seoul (KR); Kyu Hong Ahn, Seoul (KR)

Correspondence Address: HAMRE, SCHUMANN, MUELLER & LARSON, P.C., P.O. BOX 2902, MINNEAPOLIS, MN, 55402-0902, US

(73) Assignee: KOREA INSTITUTE OF SCIENCE AND TECHNOLOGY, Seoul (KR)

(21) Appl. No.: 12/553,377

(22) Filed: Sep. 3, 2009

(30) Foreign Application Priority Data
Sep. 9, 2008 (KR) 10-2008-0088897
Jun. 17, 2009 (KR) 10-2009-0053884

(51) Int. Cl. G01N 21/88

(52) U.S. Cl. 356/237.3

(57) ABSTRACT

Provided is a method for detecting a membrane module flaw, including: preparing fluorescent particles having a size of 0.5 to 1.5 μm using silica; injecting the fluorescent particles in a concentration of greater than 0 mg/mL and less than 0.1 mg/mL or equal into a membrane module used in a sewage and wastewater treatment process; operating a pump to apply a pressure such that the fluorescent particles injected into the membrane module leak to the outside of the membrane module, in case that the membrane module has a flaw; acquiring a digital image of the membrane module; and discriminating a colored portion from a non-colored portion in the digital image.

### CROSS-REFERENCE TO RELATED APPLICATION

This application claims priorities to Korean Patent Application No. 2008-0088897, filed on Sep. 9, 2008, and Korean Patent Application No. 2009-0053884, filed on Jul. 17, 2009. All the benefits accruing therefrom under 35 U.S.C. §119, and the contents of which in their entirety are herein incorporated by reference.

### BACKGROUND

1. Field

This disclosure relates to a method for detecting a membrane module flaw using fluorescent particles, capable of detecting whether a membrane module of a water treatment reactor used in a sewage and wastewater treatment process has a flaw or not.

2. Description of the Related Art

Since a sewage and wastewater treatment process using membranes does not need a depositing reservoir, a sufficient amount of water can be treated even in a small space. Also, automation can be easily achieved to facilitate operation, and high treatment efficiency can be obtained. Therefore, the process is being spotlighted as a next generation water treatment technique.

As solid-liquid separation is performed by filtration through a membrane such as a microfiltration (MF) membrane or ultrafiltration (UF) membrane, all kinds of solids having a size of less than micrometers as well as microorganisms can be separated, which makes it possible to produce highly purified water. Therefore, the process is being recognized as an alternative which can overcome various defects of an existing water treatment process.

In particular, since nano-sized particles as well as micro-sized particles can be removed depending on the type of used membranes, the process can produce reclaimed water. From this point of view, the process is a very useful process. Thanks to such advantages, the application possibility of membrane is increasing more and more.

However, a problem in performing the water treatment process using membranes is how to detect defects of the membranes.

The detection and management of physical flaws (scratch, tear, holes and so on) on a membrane surface caused by operation of a membrane, reduction in durability of the membrane material, leakage caused by a flaw of the junction between the membrane and a frame, and chemical flaws of the membrane surface and the frame caused by frequent chemical cleanings is an important problem when the process is applied on the spot. It is important to find out a problem through frequent detection the surface state of the membrane and to take measures quickly, because it can affect the quality of treated water as well as the efficiency of the membrane process.

When a flaw such as a minute tear or hole occurs on the surface of the membrane, fine particles are not filtered by the membrane, but are discharged to runoff water. As a result, it may degrade the quality of treated water. Further, when an inline chemical cleaning is performed, a cleaning solution may not be uniformly applied onto the entire surface of the membrane but may leak through the flaw. In this case, it is impossible to obtain a desired cleaning effect.

So far, a standard technique has not been reported, which can check which membrane is flawed among a number of membranes. Only by detecting a change in differential pressure between membranes or a turbidity change of runoff water based on the experience or know-how of an operator, a membrane flaw can be roughly guessed. In such a situation, it is almost impossible to find which membrane of a certain membrane module is flawed to what extent.

Currently, in order to precisely inspect the integrity of a membrane surface, membranes should be detached from the module, and whether the individual membranes are flawed or not should be observed with naked eyes.

In this case, however, a large amount of manpower and time is required, and subjectivity and uncertainty for the observation of membrane flaw with naked eyes does not guarantee precise detection. Further, unless a membrane having a flaw is accurately detected, the whole membranes should be replaced. Then, it will cost a great deal.

### SUMMARY

In one aspect, there is provided a method for detecting a membrane module flaw, including preparing fluorescent particles having a size of 0.5 to 1.5 μm using silica; injecting the fluorescent particles in the concentration of greater than 0 mg/mL and less than 0.1 mg/mL or equal into a membrane module used in a sewage and wastewater treatment process; operating a pump to apply a pressure such that the fluorescent particles injected into the membrane module leak to the outside of the membrane module, when the membrane module has a flaw; acquiring a digital image of the membrane module; and discriminating a colored portion from a non-colored portion in the digital image.

In another aspect, there is provided a method for detecting a membrane module flaw, including preparing first and second fluorescent particles having a size of 0.5 to 1.5 μm using silica, the first and second fluorescent particles respectively emitting first and second colors different from each other; injecting the first and second fluorescent particles in the concentration of greater than 0 mg/mL and less than 0.1 mg/mL or equal, to the inside or outside of a membrane module used in a sewage and wastewater treatment process; operating a pump to apply a pressure such that the first fluorescent particles injected to the outside of the membrane module leak to the inside of the membrane module, when the membrane module has a flaw; operating the pump to apply a pressure such that the second fluorescent particles injected to the inside of the membrane module leak to the outside of the membrane module, when the membrane module has a flaw; acquiring a digital image of the membrane module; and discriminating a portion colored with a superposed color of the first and second colors from a non-colored portion in the digital image.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 shows a photograph obtained by taking fluorescent particles, which are used in a flaw detection method disclosed herein, through a transmission electron microscopy (TEM);

FIG. 2 shows a state in which a membrane used in the flaw detection method disclosed herein is submerged in a sewage and wastewater treatment tank;

FIG. 3 is a schematic view of a method for detecting a membrane module flaw using monochromatic fluorescent particles; and

FIG. 4 is a schematic view of a method for detecting a membrane module flaw using two or more kinds of fluorescent particles emitting different colors from each other.

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

Disclosed herein is a method for detecting a membrane module flaw using fluorescent particles. Since the method can be used to construct an integrity inspection system for membrane modules installed in sewage and wastewater treatment facilities, individual membranes do not need to be detached from a water treatment reactor into which the membranes are applied, unlike the related art. Therefore, the minimum human resources may be used to quickly and economically detect whether the surfaces of the membranes are flawed or not. Further, as compared with a naked-eye observation, an objective observation result can be provided to detect the membrane module flaw, which makes it possible to precisely and efficiently detect how the much membrane module is flawed.

Another method for detecting a membrane module flaw using two or more kinds of fluorescent particles emitting different colors from each other is disclosed herein, which is applicable in a sewage and wastewater treatment process. The method can be used when a precise detection of membrane flaws is required. For example, when materials emitting the same or similar color with monochromatic fluorescent particles are included in water or a membrane, module and some portions seem like flaws even though they are not. By using the method, detection errors which may be caused by using monochromatic fluorescent particles may be prevented. Therefore, it is possible to precisely detect whether the membrane module is flawed or not.

The fluorescent particles used in the method disclosed herein are not specifically limited, as long as the size of them can be controlled, they have a high degree of emitting color and high strength, and they are not harmful to the environment, so that they are suitable for a sewage and wastewater treatment process. For example, there may be provided quantum dot nano-particles, as nano-sized semiconductor particles which emit light when being excited by energy such as light, which emit different colors of light depending on the size of the particles, or particles which are prepared by binding organic fluorescent materials to the functional groups of the particles.

In general, membrane flaws caused during a sewage and wastewater treatment process are measured in scales of several millimeters to several tens of centimeters. Therefore, when a membrane module has a flaw, fluorescent particles may be introduced or leaked through the flaw. In this case, it is possible to detect the flaw of the membrane module by observing the fluorescent particles based on their movement.

Accordingly, to precisely detect the flaw of the membrane module, the size of the fluorescent particles should be properly determined in accordance with the size of membrane pore and the size of the flaw. That is, the pore size and the flaw size of the membrane should be discriminated to induce the leakage of the fluorescent particles only through the flaw, in order to detect the flaw of the membrane module. Therefore, the size of the fluorescent particles may be larger than that of the membrane pore.

Specifically, the size of the fluorescent particles may be three to five times larger than that of the membrane pore of the membrane module. Considering that a membrane of a membrane module used in a sewage and wastewater treatment process has a pore size of 0.1 to 0.3 μm, the size of the fluorescent particles may range from 0.5 to 1.5 μm.

A method of preparing the fluorescent particles is not specifically limited. For example, a physical method such as a gas evaporation method, a sputtering method, a vacuum evaporation method, a mechanic alloying method, high-energy reaction milling, cryomilling, an arc discharge method or cryomelting, a chemical liquid method such as a coprecipitation method, a sol-gel method, hydrothermal synthesis or pyrolysis of organic metal compounds, and a chemical vapor method such as an aerosol method, a vapor hydrolysis method, a chemical deposition method or a chemical vapor deposition method may be used to prepare the fluorescent particles. Among them, the fluorescent particles may be prepared on the basis of the sol-gel method.

The fluorescent particles which are suitable for a sewage and wastewater process and unharmful to the environment may be fluorescent particles formed from silica. Such fluorescent particles may be used in a concentration of greater than 0 mg/mL and less than 0.1 mg/mL or equal. When the fluorescent particles are in above-described concentration, the fluorescent particles do not affect the environment. Also, the fluorescent particles do not harm DNA and cell molecules, and all of the fluorescent particles can be recovered after the flaw of the membrane module is detected. Therefore, the fluorescent particles do not affect the human body or the ecosystem.

The shape of the membrane module which may be applied to the flaw detection method disclosed herein is not specifically limited. For example, a tubular membrane module, a hollow-fiber type membrane module, a spirally wound membrane module, a plate-and-frame type membrane module, or a rotary-disk type membrane module may be used.

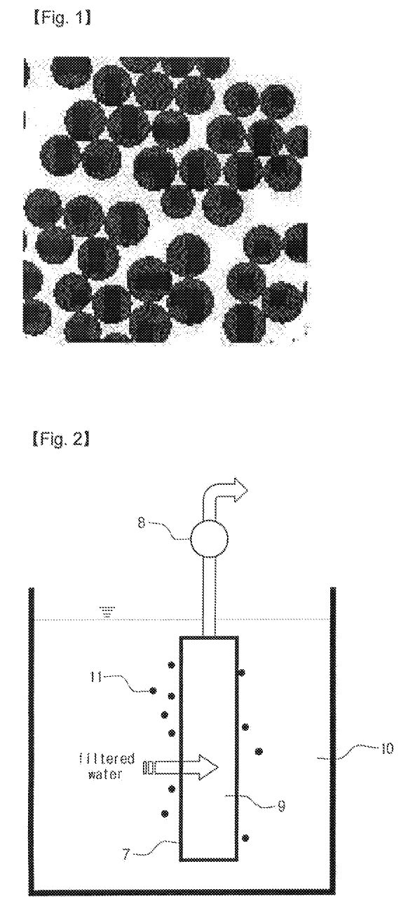

In relation to this, FIG. 1 shows a photograph obtained by taking fluorescent particles, which are used in the flaw detection method disclosed herein, through a transmission electron microscopy (TEM).

Referring to FIG. 1, when a membrane is used as a microfiltration (MF) membrane, the pore size of the membrane is 0.25 μm. Therefore, the fluorescent particles are prepared with a size of 1.0 μm which is about three times larger than that of the pore size of the membrane.

Depending on the types of fluorescent materials, the fluorescent particles may emit a variety of colors, for example the fluorescent particles may emit a red color while electrons excited by laser energy return to the ground state.

In general, when a membrane is operated, pollutant particles are filtered at the outside of the membrane, and clean water is separately discharged by being introduced to the inside from the outside of the membrane through an operation of a pump. FIG. 2 shows a state in which a membrane is submerged in a sewage and wastewater treatment tank. As shown in FIG. 2, the pump 8 is operated in a direction (hereinafter, referred to as ‘injection direction’) where water filtered from sewage and wastewater 11 may be introduced into the inside 9 of the membrane module 7 from the outside 10 of the membrane module 7.

On the contrary, in order to detect a membrane module flaw by means of the monochromatic fluorescent particles, the pump may be operated in the reverse direction to the pump operation direction of the above-described water filtration process. That is, when operating the pump to switch the direction (hereinafter, referred to as ‘reverse injection direction’) where water flows from inside to outside, and the pump is operated to apply a pressure such that the fluorescent particles injected into the membrane module leak to the outside of the membrane module, the monochromatic fluorescent particles injected into the membrane module may leak to the outside of the membrane module through a flaw in case that the membrane module has a flaw. Therefore, when the monochromatic fluorescent particles are observed outside the membrane module, it can be found that the membrane module has a flaw.

In another exemplary method disclosed herein, the flaw of the membrane module may be detected by means of two or more kinds of fluorescent particles emitting different colors from each other. In this case, the pump is operated to apply a pressure such that first fluorescent particles of a first color which are injected to the outside of the membrane module may be introduced to the inside from the outside of the membrane module by the pump operated in the injection direction. Further, the pump is operated to apply a pressure such that second fluorescent particles of a second color which are injected into the membrane module may leak from the inside of the membrane module in the reverse injection direction. Then, the flaw of the membrane module can be detected by observing whether a color resulting from the superposition of the first and second colors are appears or not.

Between the first and second fluorescent particles, the first fluorescent particles may be injected to the outside of the membrane module. When the pump is operated in the injection direction to apply a pressure such that water may flow from outside to inside, the first fluorescent particles may be introduced to inside from outside in case that the membrane module has a flaw.

As in the method for detecting a membrane module flaw using monochromatic fluorescent particles, the second fluorescent particles emitting a different color from the first fluorescent particles may be injected into the membrane module and then leak to the outside of the membrane module. When the pump is operated in the reverse injection direction to apply a pressure such that water may flow from inside to outside, the second fluorescent particles may leak to the outside from the inside of the membrane module in case that the membrane module has a flaw.

When the membrane module has a flaw, the first color of the first fluorescent particles and the second color of the second fluorescent particles injected into the membrane module are superposed around the flaw such that a third color may appear. When the superposed color is observed, it can be detected that the membrane module has a flaw.

After that, the flaw of the membrane module may be digitally imaged and detected by acquiring a digital image from the coloration by the fluorescent particles. The coloration of the fluorescent particles may be scanned by means of one or more light sources selected from the group consisting of laser beams, ultraviolet (UV) rays, X-rays, and visible rays, and simultaneously imaged by means of a digital camera or a charge-coupled device (CCD) camera. In some cases, when the coloration of the fluorescent particles can be observed with naked eyes, the above-described light sources may not be applied.

The color of the fluorescent particles acquired and imaged through the above-described process is detected in such a manner that the color of the colored portion appearing in the flaw of the membrane module and the color of non-colored portions around the membrane module are discriminated, with the help of a commonly-used image analysis program. Through this process, the flaw of the membrane module can be detected.

Hereinafter, the method disclosed herein is described more specifically with reference to drawings. However, the scope of the method disclosed herein is not limited thereto.

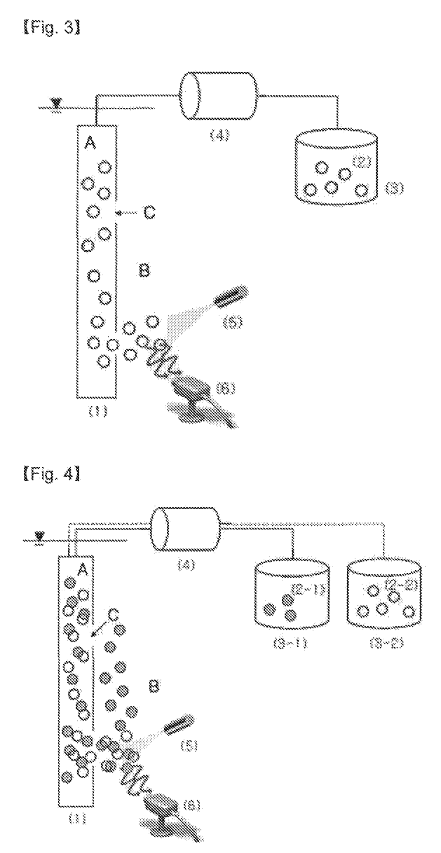

FIG. 3 is a schematic view of a method for detecting a membrane module flaw using monochromatic fluorescent particles.

Referring to FIG. 3, fluorescent particles 2 emitting a specific color are injected to the inside A of a membrane module 1 from a tank 3 storing the fluorescent particles 2, and the fluorescent particles 2 having a size of about 1.0 μm, larger than the pore of the membrane having a size of 0.1 to 0.3 μm, are reserved in the membrane module. When the membrane module 1 is torn or has a flaw C, the injected fluorescent particles 2 leak to the outside B of the membrane module 1 through the flaw C with a size of several millimeters to several tens of centimeters by a pump 4 which is operated in the reverse injection direction (A→B) such that water filtered by a treatment tank flows from the inside A to the outside B of the membrane module 1.

The leaked fluorescent particles 2 are scanned through a UV light source 5 and simultaneously imaged through a digital camera or CCD camera 6. When the leaked fluorescent particles 2 can be observed with the naked eye depending on the characteristic of the fluorescent particles 2 and the surface state of the membrane module, a separate external light source is not needed. As the digital image acquired through the digital imaging process is analyzed by discriminating a colored portion and non-colored portions through a commonly used image analysis program, it is possible to grasp whether the membrane module 1 is flawed or not and where the position of the flaw C is.

After the detection for the fluorescent particles 2 leaked to the outside B of the membrane module 1 is completed, the pump 4 is operated to collect the fluorescent particles inside and outside the membrane module into the tank 3.

FIG. 4 is a schematic view of a method for detecting a membrane module flaw using two or more kinds of fluorescent particles emitting different colors from each other.

Referring to FIG. 4, first fluorescent particles 2-1 stored in a tank 3-1 are injected to the outside B of a membrane module 1, and a pump 4 is operated in the injection direction (B→A) such that water filtered in a treatment tank flows to the inside A from the outside B of the membrane module 1. When the membrane module 1 has a flaw C, the first fluorescent particles 2-1 injected to the outside B are introduced to the inside A of the membrane module 1 by the pump 4.

As in FIG. 2, second fluorescent particles 2-2 are injected to the inside A of the membrane module 1 from a tank 3-2 storing the second fluorescent particles 2-2. When the membrane module 1 is torn or has a flaw C, the second fluorescent particles 2-2 leak to the outside B of the membrane module 1 through the flaw C having a larger size than the fluorescent particles 2 by the pump 4 which is operated in the reverse injection direction (A→B) such that the water filtered in the treatment tank flows to the outside B from the inside A of the membrane module 1.

As the color of the first fluorescent particles 2-1 and the color of the second fluorescent particles 2-2 emitting a different color from the first fluorescent particles 2-1 are superposed around the flaw such that a portion colored with a third color (mixed color) and non-colored portions are discriminated, the flaw C of the membrane module 1 is detected. After that, the color resulting from the superimposition of the colors of the respective fluorescent particles 2-1 and 2-2 is scanned by means of a light source and imaged as in FIG. 3.

In the method for detecting a membrane module flaw disclosed herein, it is possible to check whether a membrane module of a water treatment reactor provided with a membrane has a flaw or not and which portion of the membrane module is flawed, by using fluorescent particles without detaching the membrane. Therefore, the flaw detection can be efficiently performed, and whether the membrane has a flaw or not can be detected objectively and precisely, compared with the related art in which the flaw detection is checked with naked eyes.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. A method for detecting a membrane module flaw, comprising:
preparing fluorescent particles having a size of 0.5 to 1.5 μm using silica;
injecting the fluorescent particles in a concentration of greater than 0 mg/mL and less than 0.1 mg/mL or equal, into a membrane module used in a sewage and wastewater treatment process;
operating a pump to apply a pressure such that the fluorescent particles injected into the membrane module leak to the outside of the membrane module, in case that the membrane module has a flaw;
acquiring a digital image of the membrane module; and
discriminating a colored portion from a non-colored portion in the digital image.

2. A method for detecting a membrane module flaw, comprising:
preparing the first and the second fluorescent particles having a size of 0.5 to 1.5 μm using silica, the first and second fluorescent particles respectively emitting different colors from each other;
injecting the first and second fluorescent particles in a concentration of greater than 0 mg/mL and less than 0.1 mg/mL or equal, to the inside or outside of a membrane module used in a sewage and wastewater treatment process;
operating a pump to apply a pressure such that the first fluorescent particles injected to the outside of the membrane module leak to the inside of the membrane module, in case that the membrane module has a flaw;
operating the pump to apply a pressure such that the second fluorescent particles injected to the inside of the membrane module leak to the outside of the membrane module, in case that the membrane module has a flaw;
acquiring a digital image of the membrane module; and
discriminating a portion colored with a superposed color of the first and second colors from a non-colored portion in the digital image.

3. The method according to claim 1, wherein the membrane module is one or more selected from the group consisting of a tubular membrane module, a hollow-fiber type membrane module, a spirally wound membrane module, a plate-and-frame type membrane module, and a rotary-disk type membrane module.

4. The method according to claim 2, wherein the membrane module is one or more selected from the group consisting of a tubular membrane module, a hollow-fiber type membrane module, a spirally wound membrane module, a plate-and-frame type membrane module, and a rotary-disk type membrane module.
